(19) United States
(12) Patent Application Publication
(10) Pub. No.: US 2005/0190340 A1
(43) Pub. Date: Sep. 1, 2005

(54) TAN-THRU SUNGLASSES

(76) Inventor: Rolf B. Waage II, Tempe, AZ (US)

Correspondence Address: Rolf B. Waage II, 1233 E. Marigold Lane, Tempe, AZ, 85281, US

(21) Appl. No.: 10/188,411

(22) Filed: Jun. 26, 2002

(51) Int. Cl. G02C 1/00; G02C 7/10

(52) U.S. Cl. 351/41

(57) ABSTRACT

a pair of sunglass frames made of acrylite OP4 acrylic material that allow the suns rays to pass through allowing the wearer an even suntan by not omitting the U.V.A. and the U.V.B. light.

### CROSS—REFERENCE TO RELATED APPLICATION

### BACKGROUND—FIELD OF INVENTION

This invention relates to frames that allow U.V.B. light to pass through the frames which allow the person wearing them to tan through the frames. These frames are constructed out of acrylite OP4 acrylic material.

### BACKGROUND—DESCRIPTION OF PRIOR ART

Optical companies and department stores supply consumers with sunglasses. Such glasses are very light in weight and beneficial in eye protection Nevertheless, the frames of the sunglasses leave a remarkably unpleasing appearance which is conferred on them by omitting the UV rays. Commonly know as raccoon eyes or suntan line.

### SUMMARY

In accordance with the present invention the frames comprised of UV permeable acrylic that wrap around the face and allows the UV rays to tan the face evenly.

### OBJECTS AND ADVANTAGES

Accordingly, besides the objects and advantages of the tan through frame described in my above patent, several objects and advantages of the present invention are:
(a) To provide the wearer a pleasing appearance with the continuity of a suntan. to provide protection from the sun.
(b) To provide eye from physical objects such as sand, rocks, etc.
(c ) Provide strong, lightweight and durable sport glasses.
(d) To provide strong, lightweight and durable sport glasses.
   Further objects and advantages are to provide the consumer with sunglasses of the variety that allow sunlight to pass through the frames for a pleasing tan. Also, which are conveniently and easily usable by the wearer. Still further objects and advantages will become apparent from a consideration from the from the ensuing drawings.

### DRAWING FIGURES

In the drawing closely related figures have the same number but different alphabetic suffixes.

FIG. 1a to Fig 1e shows various aspects of sunglass frames that will wrap around wearer face composed of acrylite OP4 acrylic.

FIG. 2 show the selected wrap angle that sit on the wearers nasal rest.

FIG. 3 how the temple hinge that is secured to one end of the support rod that can be moved to a folded position in which they lie substantially parallel to the lenses.

### REFERENCE NUMERALS IN DRAWINGS

a right arm d left hinge

b left arm e nasal rest

c right hinge

d left hinge

e nasal rest

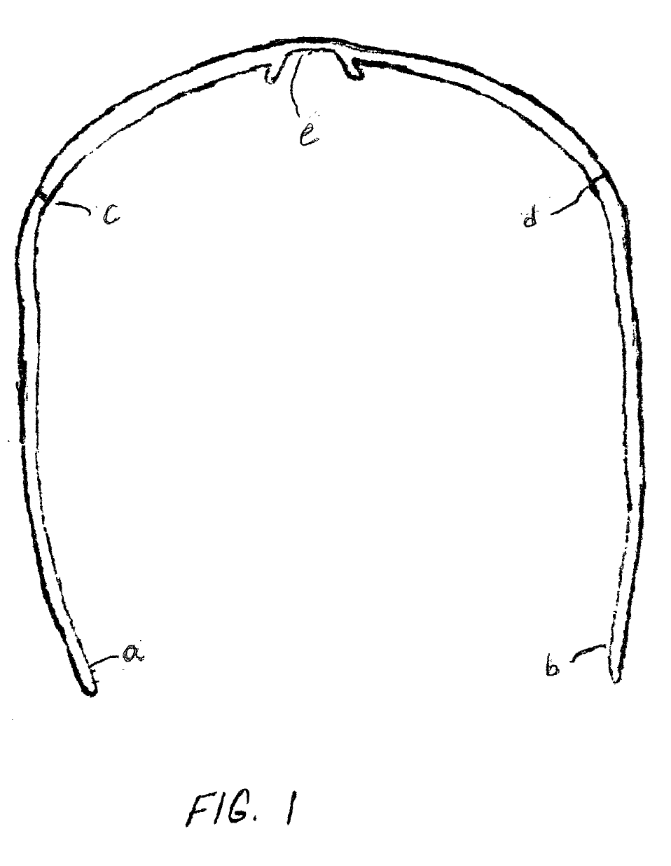

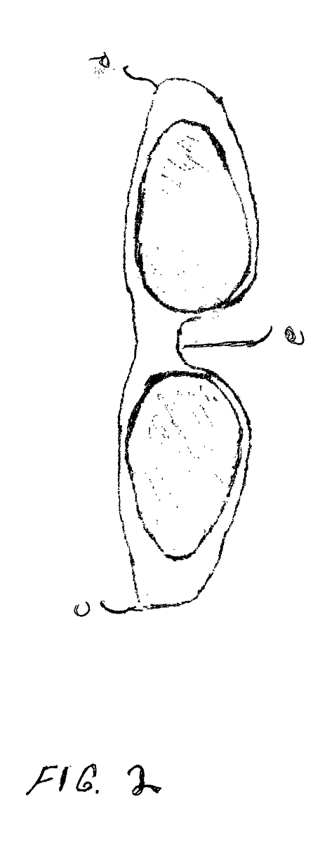

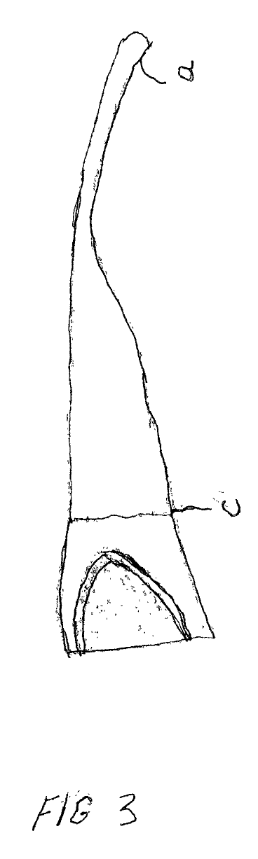

Operation FIGS. 1, 2, and 3

The manner of using the tan thru sunglasses consist of a frame and a pair of lenses attached to said frame and positioned over respective wearer's eyes. The frames being sized and configured such that when positioned around wearer's head and thereby in a manner wherein the normal line of sight of each of the wearer's eyes allowing sunlight to the frame to permeate the glasses.

Advantages

From the description above, several advantages of the Tan-thru frames become evident:
(a) The frames will not leave highly visible or semi-permanent marks on the wearer's face
(b) The frames will be beneficial with prescription lenses that block UV rays.
(c The frames will be available in different colors.
(d) Light weight sport glasses.
(e) durability and strength.
(e) light weight frames that are comfortable that may be worn for long durations.
   Conclusion, Ramifications, and Scope

Accordingly, the reader will see that the Tan-thru frames of this inventor can be used to protect the wearer's face and give it the continuity of suntan lines.
They are comfortable
They provide the wearer of the frames to enhance their attractiveness.
They are durable.
They provide the wearer to choose the colors of the frames to suit their personality.
They provide the wearer more beneficial use when used with prescription lenses.

Although the description above contains many specificities, these should not be construed as limiting the scope of the invention but, merely illustration of some of the presently preferred embodiments of this invention. For example the frames can have other shapes such as circular, oval, etc.

Thus the scope of the invention should be determined by the appended claims and equivalents rather than by the examples given.

A pair of sunglass frames that are comprised of acrylite OP4acrylic that allows the sun to tan through giving the wearer an even suntan.

1. Said frames are lightweight strong and durable enough whereby a human can wear them for long periods of time when playing sports.

2. Said frames allow the wearer approximately an even suntan.

3. Said frames may be tinted substantially in various colors.

4. Said frames may consist of approximately fashionable styles.
